(19) United States
(12) Patent Application Publication
(10) Pub. No.: US 2014/0290020 A1
(43) Pub. Date: Oct. 2, 2014

(54) RING SEAL INSTALLATION TOOL

(71) Applicant: Caterpillar Inc., Peoria, IL (US)

(72) Inventors: Anupam Radhakrishnan, Normal, IL (US); James W. Balfanz, Chillicothe, IL (US); Steve J. Miller, Hanna City, IL (US); Rajesh Sampath, Chennai (IN)

(21) Appl. No.: 14/307,553

(22) Filed: Jun. 18, 2014

(51) Int. Cl. B25B 27/00

(52) U.S. Cl. CPC B25B 27/0028
USPC 29/252

(57) ABSTRACT

A tool for installing a ring seal within a groove is provided. The groove is disposed within an inner diameter of a flange. The flange has an outer flange portion extended radially outward from the groove. The tool includes a rod and cylinder assembly defining a longitudinal axis along a centerline of a rod of the rod and cylinder assembly. A trigger mechanism is coupled to the rod and cylinder assembly. A flange engagement assembly is attached to the rod and cylinder assembly. The flange engagement assembly includes a main frame having a first end attached to the rod and cylinder assembly and a second end aligned with and extended along the longitudinal axis. A seal installation attachment is removably attachable to the second end of the main frame and structured and arranged to selectively overlay the inner diameter of the flange.

### TECHNICAL FIELD

The present disclosure relates to a tool, and more specifically to the tool for installing a ring seal in an internal groove of a housing.

### BACKGROUND

Large diameter sealing rings may be utilized in association with gears of different machines. For example, in a hydraulic excavator, a sealing ring may be provided on an inner diameter of the swivel gear. Upon usage, the sealing ring may need to be replaced. Installation of a new sealing ring may be a time consuming process causing high machine-down time and affecting overall productivity. Further, sometimes it may be difficult to access the sealing ring due to space constraints. Hence, there is a need for providing an improved installation tool.

U.S. Published Application Number 2011/0010930 (hereinafter referred as the '930 publication) discloses an apparatus for inserting a seal into a slewing bearing including a main body, a pressing unit, a pressure unit, an adjustment unit, and a guide unit. The main body is fixed to any one of a first ring and a second ring of the slewing bearing. The pressing unit projects from the main body toward a sealing installation position of the other one of the first ring and the second ring. The pressing unit is installed by pressing a seal supplied from the exterior to the sealing installation position toward the sealing installation position as the first ring and the second ring are relatively rotated. Therefore, the seal is installed at the sealing installation position between the first ring and the second ring of the slewing bearing. The '930 publication is useful for thinner seals or seals having more flexibility and needs human intervention to provide a force to the seal for installation thereof.

Therefore, a more robust, easily manufacturable, and external powered tool is required to install thicker seal/gaskets requiring high impact forces for attaching the seal at remote locations where tool accessibility is less.

### SUMMARY OF THE DISCLOSURE

In one aspect of the present disclosure, a tool for installing a ring seal within a groove is provided. The groove is disposed within an inner diameter of a flange. The flange has an outer flange portion extended radially outward from the groove. The tool includes a rod and cylinder assembly defining a longitudinal axis along a centerline of a rod of the rod and cylinder assembly. A trigger mechanism is coupled to the rod and cylinder assembly. A flange engagement assembly is attached to the rod and cylinder assembly. The flange engagement assembly includes a main frame having a first end attached to the rod and cylinder assembly and a second end aligned with and extended along the longitudinal axis. A seal installation attachment is removably attachable to the second end of the main frame and structured and arranged to selectively overlay the inner diameter of the flange. The rod of the rod and cylinder assembly is configured to apply a radial force to the outer flange portion of the flange in response to activation of the trigger mechanism contemporaneously with the seal installation attachment applying a radially directed force to the ring seal along a length of the seal installation attachment as the ring seal is urged into the groove.

Other features and aspects of this disclosure will be apparent from the following description and the accompanying drawings.

### BRIEF DESCRIPTION OF THE DRAWINGS

FIG. 1 is perspective view of a first embodiment of a tool for installing a ring seal, according to an embodiment of the present disclosure;

FIGS. 2 and 3 are perspective views of the tool of FIG. 1, installed on an exemplary flange; and

FIG. 4 is a perspective view of another embodiment of a tool, according to an embodiment of the present disclosure.

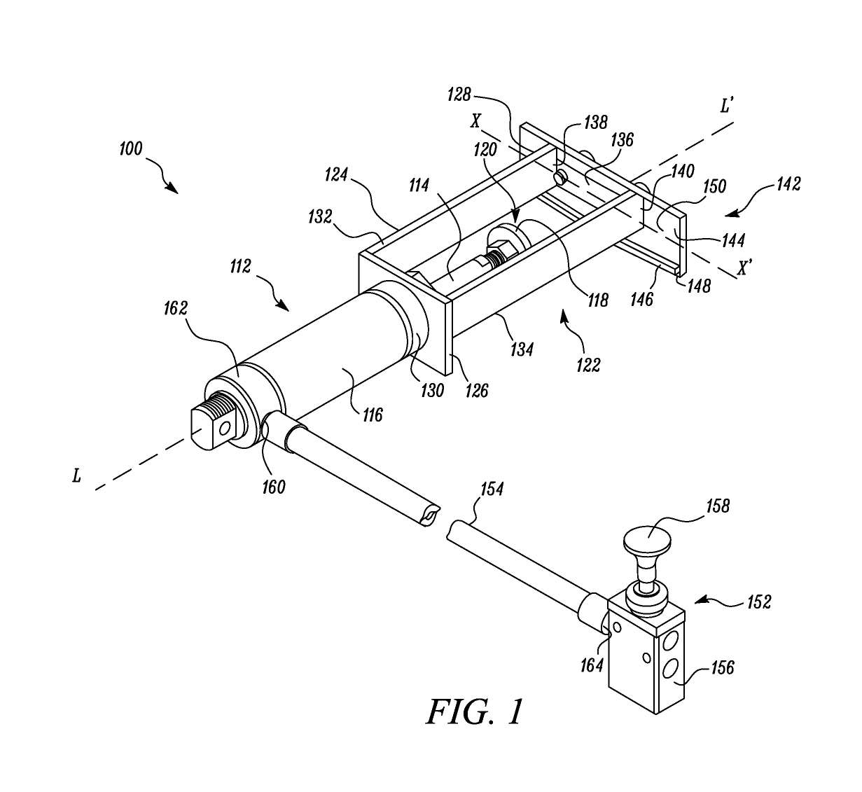

### DETAILED DESCRIPTION

Wherever possible, the same reference numbers will be used throughout the drawings to refer to the same or the like parts. FIG. 1 illustrates a tool 100 for installing a ring seal 102 within a groove 104, according to one embodiment of the present disclosure. The tool 100 may include a rod and cylinder assembly 112. The rod and cylinder assembly 112 includes a rod 114 slidably received in a cylinder 116. The rod and cylinder assembly 112 further defines a longitudinal axis L-L′ along a centreline of the rod 114. The cylinder 116 may be a pneumatic or a hydraulic cylinder 116, and the rod 114 may act as a piston for the cylinder 116. In an exemplary embodiment, the cylinder 116 used is a pneumatically operated cylinder. Further, a stopper 118 may be coupled to a free end 120 of the rod 114. In an embodiment, the stopper 118 and the rod 114 may be manufactured as a unitary component. Alternatively, the stopper 118 and the rod 114 may be separate components. The rod 114 may be configured to reciprocate along the longitudinal axis L-L′, in response to an energised or de-energised fluid flow in the cylinder 116.

The tool 100 may also include a flange engagement assembly 122 attached to the rod and cylinder assembly 112. As shown in FIG. 1, the flange engagement assembly 122 may include a main frame 124. In an embodiment, the main frame 124 may be a rectangular bracket having a first end 126 and a second end 128. The first end 126 may be attached to the rod and cylinder assembly 112. In one embodiment, the first end 126 may have a planar configuration. The first end 126 may include a hole to receive a first portion 130 of the cylinder 116. In various other embodiments, the first portion 130 of the cylinder 116 may be attached to the first end 126 by any method known in the art, such as, by using fasteners, rivets, welding and the like.

Further, the second end 128 may be aligned such that the second end 128 extends from the first end 126 along the longitudinal axis L-L′. The second end 128 may include a first rail 132 and a second rail 134. The first rail 132 and the second rail 134 may be substantially parallel to each other and to the longitudinal axis L-L′. The second end 128 may also include a backing plate 136 attached to ends 138, 140 of the first rail 132 and the second rail 134 respectively. In an embodiment, the backing plate 136, the first rail 132 and the second rail 134 are manufactured as unitary component and attached to the first end 126 using any method known in the art. In another embodiment, the main frame 124 is manufactured as a unitary component. As shown in the FIG. 1, the cylinder 116 may be positioned with respect to the first end 126 and the second end 128 such that the rod 114 may reciprocate in between the first rail 132 and the second rail 134 of the second end 128.

The flange engagement assembly 122 may further include a seal installation attachment 142. The seal installation attachment 142 may be removably attached to the second end 128 of the main frame 124. In an embodiment, the seal installation attachment 142 may be attached to the backing plate 136 of the second end 128 of the main frame 124 using fasteners, such as, for example, a nut and bolt assembly. The seal installation attachment 142 may have a plate 144 having a planar configuration and a lip portion 146 extending perpendicularly from a bottom edge 148 of the plate 144.

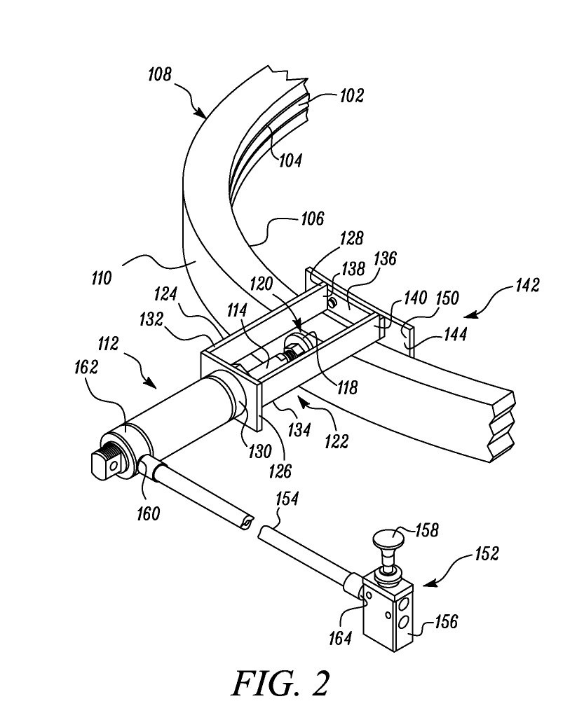

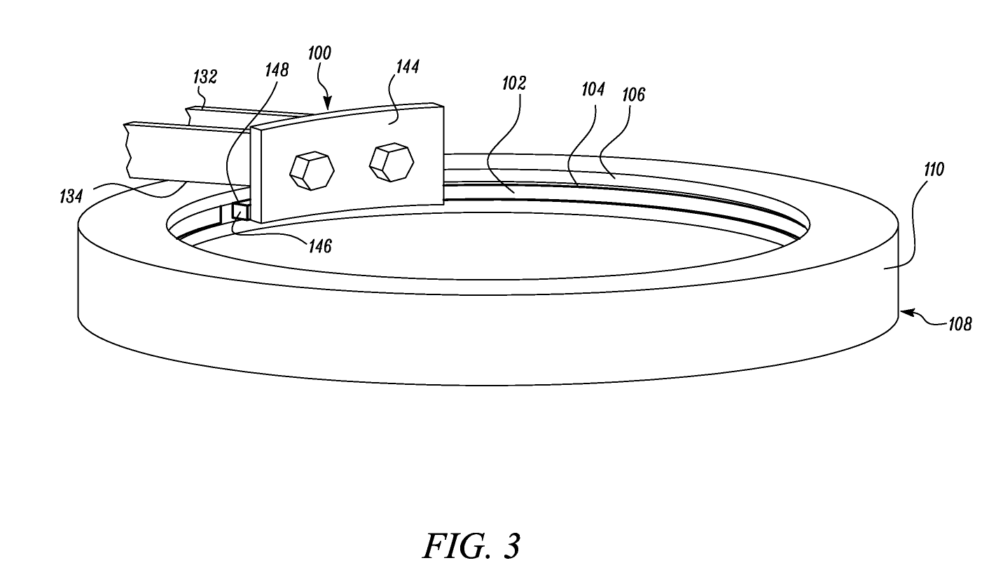

Referring to FIGS. 2 and 3, the tool 100 may be utilized to install the ring seal 102 within the groove 104. The groove 104 may be disposed within an inner diameter 106 of a flange 108. The flange 108 may include an outer flange portion 110 extended radially outward from the groove 104. In an embodiment, the flange 108 may be a swing gear.

FIG. 3 illustrates the seal installation attachment 142 overlaying the inner diameter 106 of the flange 108. Specifically, the lip portion 146 of the seal installation attachment 142 may overlay the inner diameter 106 of the flange 108. Further, the seal installation attachment 142 may be positioned such that an axis X-X′ parallel to a plane of the plate 144 is perpendicular to the first rail 132 and the second rail 134. Also, the seal installation attachment 142 is aligned such that an interior facing surface 150 of the seal installation attachment 142 is opposite to the stopper 118, at the free end 120 of the rod 114. Moreover, a transverse length of the seal installation attachment 142 and correspondingly a length of the lip portion 146 may be customizable for different machine components and size of the ring seal 102.

In an embodiment, the seal installation attachment 142 is removably attached to the second end 128 of the main frame 124. The seal installation attachment 142 of the tool 100 may be selected such that a transverse length of the seal installation attachment 142 may correspond to a portion of the ring seal 102 to be inserted within the groove 104 by using the tool 100 in a single iteration. In another embodiment, the seal installation attachment 142 including the lip portion 146 may be constructed in two parts, such that a first part may be configured to be received in a second part as a telescopic engagement. Thus, the seal installation attachment 142 may extend or retract to achieve a desired contact length between the flange 108 and the ring seal 102.

As shown in FIGS. 1 and 2, the tool 100 may include a trigger mechanism 152. The trigger mechanism 152 may include a hose 154, a fluid tank 156 and an actuator 158. One end 160 of the hose 154 is fluidly coupled to a second portion 162 of the cylinder 116, whereas the other end 164 of the hose 154 is connected to the fluid tank 156. The actuator 158 may be coupled to the fluid tank 156 and thus to the cylinder 116 through the hose 154. The actuator 158 may be a push button, a switch, a lever and the like. The actuator 158 may be configured to control a flow of energised or de-energised fluid from the fluid tank 156 to the cylinder 116 to control a movement of the rod 114 of the rod and cylinder assembly 112.

The working of the tool 100 will now be described. Referring to FIGS. 2 and 3, the tool 100 is positioned on the flange 108 such that a portion of the flange 108 may lie in between the seal installation attachment 142 and the stopper 118 at the free end 120 of the rod 114. The main frame 124 is supported on the flange 108 such that the first rail 132 and the second rail 134 lie above or contact with a top surface of the flange 108. Also, the free end 120 of the rod 114 may face the outer flange portion 110. The ring seal 102 is placed between the seal installation attachment 142 and the inner diameter 106 of the flange 108. More particularly, the ring seal 102 may contact with the lip portion 146 of the seal installation attachment 142 and the groove 104.

On activation of the trigger mechanism 152, the rod 114 of the rod and cylinder assembly 112 may apply a radial force to the outer flange portion 110 of the flange 108. As the radial force is being applied by the rod 114, the seal installation attachment 142 may simultaneously apply a radially directed force to the ring seal 102 along the length of the seal installation attachment 142, thereby urging the portion of the ring seal 102 in contact with the seal installation attachment 142 to be urged into the groove 104.

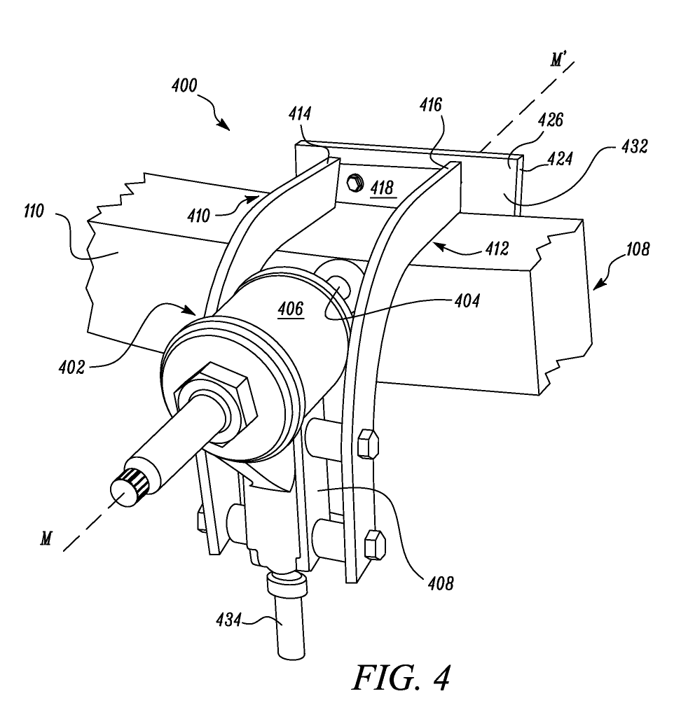

FIG. 4 illustrates another design of the tool 400 for installing the ring seal 102 within the groove 104 of the flange 108, according to other embodiments of the present disclosure. The tool 400 may include a rod and cylinder assembly 402. The rod and cylinder assembly 402 includes a rod 404 slidably received in a cylinder 406. The rod and cylinder assembly 402 further defines a longitudinal axis M-M′ along a centreline of the rod 404.

As shown in FIG. 4, the cylinder 406 may be an L-shaped cylinder 406 defining a passage portion 408 extending downward from the cylinder 406. The rod 404 may be configured to reciprocate along the longitudinal axis M-M′, in response to an energised or de-energised fluid flow in the cylinder 406. The tool 400 may also include a flange engagement assembly 410 attached to the rod and cylinder assembly 402.

The flange engagement assembly 410 may include a main frame 412. The main frame 412 may include a first rail 414, a second rail 416 and a backing plate 418. The first rail 414 and the second rail 416 may be arcuate shaped and aligned with each other. The rod and cylinder assembly 402 may be attached to the main frame 412 at a lower section of the first rail 414 and the second rail 416. The passage portion 408 of the rod and cylinder assembly 402 may be attached to the lower section of the first rail 414 and the second rail 416. It may be apparent to a person of ordinary skill in the art that the passage portion 408 of the cylinder 406 may be attached to the main frame 412 by any known method such as using fasteners, rivets, welding and the like.

The flange engagement assembly 410 may further include a seal installation attachment 424. The seal installation attachment 424 may be removably attached to the main frame 412. In an embodiment, the seal installation attachment 424 may be attached with the backing plate 418 of the main frame 412 through fasteners, such as, for example, a nut and bolt assembly.

The seal installation attachment 424 may have a plate 426 having a planar configuration and a lip portion extending perpendicularly from a bottom edge of the plate 426. During installation, the lip portion of the seal installation attachment 424 may overlay the inner diameter 106 of the flange 108. Also, the seal installation attachment 424 is aligned such that an interior facing surface 432 of the seal installation attachment 424 is opposite to a free end of the rod 404. The tool 400 may further include a trigger mechanism 434. The trigger mechanism 434 may be connected to the passage portion 408 of the rod and cylinder assembly 402 to supply the energized fluid flow.

The working of the tool 400 is similar to that explained in connection with the tool 100 illustrated in FIGS. 1 to 3. Upon actuation of the trigger mechanism 434, the rod 404 of the rod and cylinder assembly 402 may apply the radial force to the outer flange portion 110 of the flange 108. Further, the seal installation attachment 424 may in turn apply the radially directed force to the portion of the ring seal 102, causing the ring seal 102 to be urged into the groove 104.

### INDUSTRIAL APPLICABILITY

For construction machines such as, excavators, cranes, backhoe loaders, and other similar machines having large diameter gears, it may be difficult to install and replace a ring seal. For example, in the excavator, the gears may be provided on a swivel support to facilitate tilting or rotation of a top portion such as, an operator station of the machine relative to an undercarriage. The swivel support of the machine may be lubricated internally with lubricating oils for smooth operation. The ring seal is installed within the groove of the gear in order to seal a space in the gear and control leakage of the lubrication oil therethrough. The ring seal may be any mechanical seal such as, a gasket, circlip, seal, and other similar large diameter rings.

Due to operation and usage, the ring seal may need to be replaced from time to time. However, the time needed to install the ring seal is high, which in turn may increase an idle time of the machine and further affect overall machine productivity. Additionally, due to space constraints it may be difficult for an operator to access the ring seal for maintenance or servicing purposes.

The present disclosure is related to the tool 100, 400 for installing the ring seal 102 within the groove 104 of the flange 108. The tool 100, 400 may be specifically useful for installing the ring seal 102 having a large diameter. As described above, the installation procedure may involve actuation of the trigger mechanism 152, 434 by the operator, causing the rod 114, 404 of the rod and cylinder assembly 112, 402 to push towards the outer flange portion 110. Simultaneously, the seal installation attachment 142, 424 may be pulled towards the inner diameter 106 of the flange 108, such that the lip portion 146 of the seal installation attachment 142, 424 may press the ring seal 102 into the groove 104.

This same procedure may be repeated around a circumference of the flange 108, such that with each usage of the tool 100, 400, distinct portions of the ring seal 102 may be urged within the groove 104 of the flange 108. While using the tool 100, 400, a desired fluid pressure may be applied through the trigger mechanism 152, 434 and correspondingly a desired amount of force may be applied by the seal installation attachment 142, 424 to perform sealing. Further, the transverse length of the seal installation attachment 142, 424 may be adjusted as so to control a contact length between the ring seal 102, the lip portion 146 and the groove 104.

Moreover, the installation attachment 142, 424 may be replaced with like attachments of differing radii to accommodate seal installation on flanges of different sizes making the tool 100, 400 versatile and usable for many different flange sizes. The tool 100, 400 may be customized for multiple types of machines based on the application. Also, as the tool 100, 400 may be affixed on the outer flange portion 110 of the flange 108, it may be easier to operate the tool 100, 400 and install the ring seal 102 in a setup wherein little or no space is present axially above the flange 108. The tool 100, 400 has a light weight design which may be handled and used easily. The installation time for the ring seal 102 may be reduced by the usage of the disclosed tool 100, 400.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A tool for installing a ring seal within a groove, the groove being disposed within an inner diameter of a flange, the flange having an outer flange portion extended radially outward from the groove, the tool comprising:
a rod and cylinder assembly defining a longitudinal axis along a centerline of a rod of the rod and cylinder assembly;
a trigger mechanism coupled to the rod and cylinder assembly; and
a flange engagement assembly attached to the rod and cylinder assembly, the flange engagement assembly including:
a main frame having a first end attached to the rod and cylinder assembly and a second end aligned with and extended along the longitudinal axis; and
a seal installation attachment being removably attachable to the second end of the main frame and structured and arranged to selectively overlay the inner diameter of the flange,
wherein the rod of the rod and cylinder assembly is configured to apply a radial force to the outer flange portion of the flange in response to activation of the trigger mechanism contemporaneously with the ring seal installation attachment applying a radially directed force to the ring seal along a length of the seal installation attachment as the ring seal is urged into the groove.
